(19) United States
(12) Patent Application Publication
(10) Pub. No.: US 2024/0311879 A1
(43) Pub. Date: Sep. 19, 2024

(54) DYNAMIC SEARCH QUERYING

(71) Applicant: Four Charm Technologies, LLC, Birmingham, AL (US)

(72) Inventor: Rawdon W. Kellogg, Guntersville, AL (US)

(21) Appl. No.: 18/228,582

(22) Filed: Jul. 31, 2023

Related U.S. Application Data
(60) Provisional application No. 63/468,146, filed on May 22, 2023.
(60) Provisional application No. 63/451,756, filed on Mar. 13, 2023.

(51) Int. Cl. G06Q 30/0282; G06F 3/04847; G06Q 30/0601

(52) U.S. Cl. CPC G06Q 30/0282; G06F 3/04847; G06Q 30/0625; G06Q 30/0627; G06Q 30/0631

(57) ABSTRACT

A method provides a user interface including a search results section and a search adjustment section. The method determines factors, and factor ranges, and environment trigger conditions. The method modifies the factors in response to determining a first environment trigger condition of the environment trigger conditions. The method adjusts factor ranges in response to determining a second environment trigger condition of the environment trigger conditions. The method receives factor weights for the modified plurality of factors, the factor weights being within the adjusted plurality of factor ranges. The method scores search results using the factor weights. The method then ranks the search results in response to scoring the search results.

### PRIORITY

This application claims the benefit of both U.S. Provisional Application No. 63/451,756, filed Mar. 13, 2023, entitled “MARKETING ENGINE FOR USER-SPECIFIC SEARCH RESULTS”, and naming Rawdon W. Kellogg as the inventor and U.S. Provisional Application No. 63/468,146, filed May 22, 2023, entitled “MARKETING ENGINE FOR USER-SPECIFIC SEARCH RESULTS”, and naming Rawdon W. Kellogg as the inventor. The contents of these applications are hereby incorporated by reference in their entirety, as if fully set forth herein.

### INCORPORATION BY REFERENCE

The present application is related to search engines incorporating features such as fingerprints, as disclosed in U.S. application Ser. No. 17/035,613, the entire disclosure of which is hereby incorporated by reference herein.

### BACKGROUND

Illustrative embodiments of the invention generally relate to search engines and, more particularly, various embodiments of the invention relate to customizing search results for a user. Some search engines allow a user to query a database for information. Over time, information may be added to the database or information may be taken away. Search queries performed before database changes may be less accurate compared to a new search query performed after the database changes.

### SUMMARY OF VARIOUS EMBODIMENTS

In accordance with one embodiment of the invention, a method provides a user interface including a search results section and a search adjustment section. The method determines factors, and factor ranges, and environment trigger conditions. The method modifies the factors in response to determining a first environment trigger condition of the environment trigger conditions. The method adjusts factor ranges in response to determining a second environment trigger condition of the environment trigger conditions. The method receives factor weights for the modified plurality of factors, the factor weights being within the adjusted plurality of factor ranges. The method scores search results using the factor weights. The method then ranks the search results in response to scoring the search results.

The plurality of environment trigger conditions may have an updated essential status for one of the plurality of factors, and wherein the method comprises removing a portion of the plurality of search results from the plurality of search results based on one factor of the plurality of factors corresponding to the updated essential status.

In some embodiments, the method adds a new search result to the plurality of search results in response to a third environment trigger condition of the plurality of environment trigger conditions.

The environment trigger conditions may include a change in availability of an item corresponding to one of the plurality of search results.

The method may remove a first search result from the plurality of search results in response to evaluating a third environment trigger condition of the plurality of environment trigger conditions.

The method may rescore the plurality of search results in response to evaluating a fourth environment trigger condition of the plurality of environment trigger conditions.

Modifying the plurality of factors may be adding a new factor to the plurality of factors in response to one of the plurality of environment trigger conditions or removing a first factor from the plurality of factors in response to one of the plurality of environment trigger conditions.

The user interface is configured to provide a vendor search result, and the method may update the plurality of factors in response to the plurality of environment trigger conditions and update the vendor search result in response to the updated plurality of factors.

The user interface may provide a vendor search result and the method may update the plurality of factor ranges in response to the plurality of environment trigger conditions and update the vendor search result in response to the updated plurality of factor ranges.

In some embodiments, the method captures an image of a bar code corresponding to a supplemental search result and reranks the plurality of search results. The plurality of environment trigger conditions may include a receipt of a new search result. The reranked plurality of search results may include a rank for the new search result.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 schematically shows a user interface in accordance with various embodiments.

FIG. 2 schematically shows a search entry section in accordance with various embodiments.

FIG. 3 schematically shows a portion of a search adjustment section for entering user features in accordance with various embodiments.

FIGS. 4 and 5 schematically show a section of the user interface visually representing a fingerprint in accordance with various embodiments.

FIGS. 6-7 schematically shows the user interface in accordance with various embodiments.

FIGS. 8-11 schematically show search adjustment sections in accordance with various embodiments.

FIG. 12 shows a process for ranking dynamic search results in accordance with various embodiments.

FIG. 13 illustrates an exemplary computing system in accordance with various embodiments.

### DESCRIPTION OF ILLUSTRATIVE EMBODIMENTS

In illustrative embodiments, a search engine allows a user to build a search query using search terms as well as other search criteria provided by the user to determine user-specific search results. The search engine may provide an interface to allow the user to enter search criteria on a search results page after entering search terms on a search term entry page.

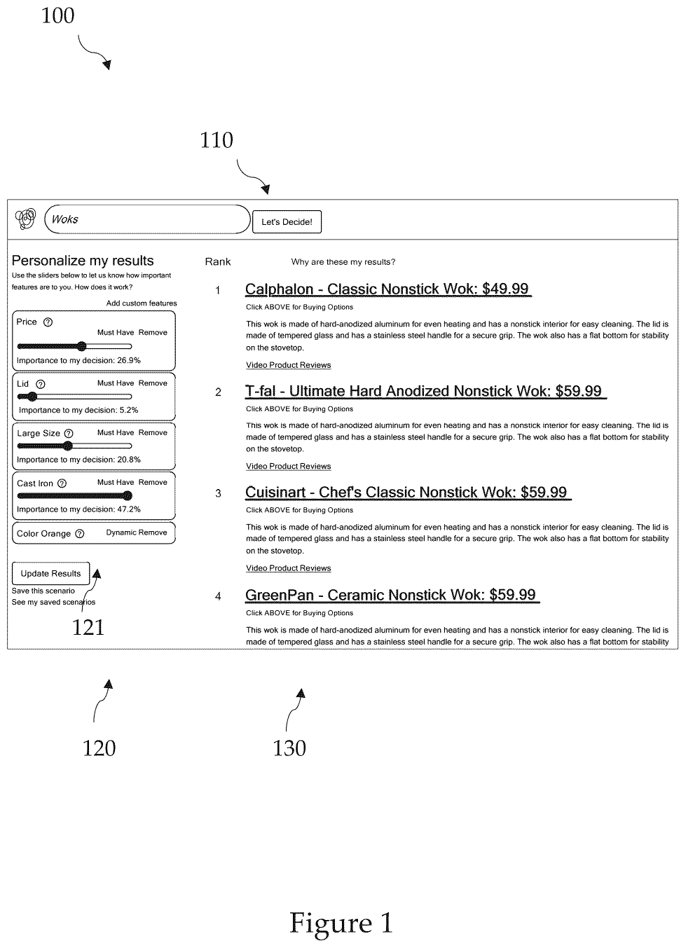

FIG. 1 schematically shows a user interface 100 configured to display search results and receive input from the user corresponding to search queries and factors, in accordance with various embodiments. The user interface 100 includes a search entry section 110 configured to receive the search query from the user. In the illustrated example in FIG. 1, the user inputs “Woks” and clicks the “Let's Decide” button. A search engine or marketing engine then determines relevant factors for further input by the user to personalize the search. The user interface 100 includes a search adjustment section 120 where the user may add or remove factors, change the type of each factor between mandatory or weighted, and input weights for the weighted factors, among other things. The relevant factors may be displayed on the user interface 100 alongside initial search results in the search results section 130. In some embodiments, the initial search results are derived from default weights applied to the weighted factors determined using the initial search terms. Search results may be ranked and shown in an initial order.

After submitting the search query, the user may be prompted to give further input to personalize the search results. These further inputs may include weighted factors, identified by the user or system in response to the search terms in the initial search query. After the user interface adds or removes weighted factors, the user may assign a weight to the weighted factors, remove the weighted factor from search consideration, or convert the weighted factor to a mandatory factor. The user may assign a weight using a controllable element in the form of a slider tool, among other things.

The sidebar, also known as the search adjustment section 120, allows the user to personalize results. As the user interacts with the sidebar, such as by assigning weights, the search results may update in real time. The user interface 100 may display helper text to guide users in moving the sliders when hovering over or clicking on the encircled question marks in the sidebar. Once a slider is changed, the “Update Results” button may no longer be disabled and the user may select the button to refresh the search results. In other embodiments, the search results are updated in response to the user updating the weighted factors, search terms, or mandatory factors without interacting with a controllable element.

The sidebar may also include a text field for the user to add weighted factors to the initial list of weighted factors. The sidebar may also include a listing of possible weighted factors the user may add to the search.

In some embodiments, a search query may be analyzed based on the assigned value to the weighted factors as well as faceted criteria, also known as mandatory factors. For example, a user may search for woks as illustrated in FIG. 1. While flexible on other aspects of the woks, the user requires a lid. Rather than weighting the factor of “Lid” as more important than other factors, the user may indicate a factor is to be treated a prerequisite rather than assigning a weight, also known as assigning an essential status. As shown in FIG. 1, the user interface 100 may have controllable elements to allow the user to select one of the weighted factors to convert the factor from weighted to a mandatory factor. To change a weighted factor criterion to a faceted criterion, the user may select the link “must have.” To change a faceted criterion to a weighted factor criterion, the user may select the link “dynamic.”

In some embodiments, the faceted criterion may include objective aspects of the search while the weighted factor criterion includes subjective aspects. For example, a faceted criterion may include a color or shoe size, while a weighted factor may include price or comfort.

By using a faceted criterion rather than a heavily weighted factor for the color, the other weighted factors used for the search may still be meaningfully weighted while the results still reflect the required color.

In some embodiments, potential search results are stored in a database. The database may be updated periodically by adding, removing, or changing potential search results. The search results received by the user may be static results derived from a version of the database.

In other embodiments, the search results are updated dynamically based on a change to the search engine, referred to herein as environment trigger conditions. For example, the search results may be updated in response to a change in the possible search results or a change in an artificial intelligence model selecting search results based on the criteria designated by the user.

The search engine may monitor environment trigger conditions for adjusting the displayed page. For example, certain conditions may trigger the addition of a weighted factor, the removal of a weighted factor, the adjustment of a range of values assignable to a weighted factor, the availability of a search result, or the ranking of a search result, among other things.

In one example of a search engine with dynamic updates, a user may operate a search engine for a campground where the user specifies criteria for a campsite. The results may be displayed based on the initial criteria and then the displayed search results may be updated as other users purchase campsites such that purchased campsites are removed from the search results. The results may also be updated when a factor is removed or added from the listed of weighted factors considered by the search. For example, the search engine may monitor the weather of the campground and add a weighted factor for paved/unpaved after a campground receives a downpour of rain making it more difficult for some campers to navigate some of the campground/campsites.

In another example of a search engine with dynamic updates, a user may be traveling along the interstate while searching for a place to eat. As the user passes an exit, the search results may eliminate restaurants located at the passed exit based on a geolocation environment trigger condition.

In some embodiments, a search query may include data derived from an image captured by a computing system. For example, a computing system may capture an image of a bar code, such as a QR code, among other things, corresponding to a possible search result, a search result collection, or a fingerprint, among other things. In one example, the data from the captured image corresponds to one search result such as a product. The data may be item specific. For example, in addition to having factory data for a car such as miles per gallon, the data derived from the capture image may correspond to actual vehicle gas mileage, an odometer reading, or a maintenance history, among other things.

A user may scan a QR code of a product (e.g., an apple, a car, or a house) while shopping. The QR code corresponds to the data required by the search engine to score the product using the user's fingerprint. For example, while car shopping, the user may scan a QR code corresponding to a car on a dealership lot. In response, the search engine may display a search results page having the sidebar of adjustable weight factors along with data about the car and a score for the car based on the user fingerprint and/or weighted factors in the sidebar.

In another example, the user may scan a QR code at a car dealership corresponding to inventory data for the dealership. After scanning the QR code, the search engine may display results comprising the available vehicles and corresponding scores based on the user fingerprint. In this way, the user may user their fingerprint to rank the available cars on a vehicle lot.

In another example, a user may share their fingerprint with an agent who uses the fingerprint to identify products for purchase. For example, a real estate agent may user the fingerprint to generate a list of houses for purchase.

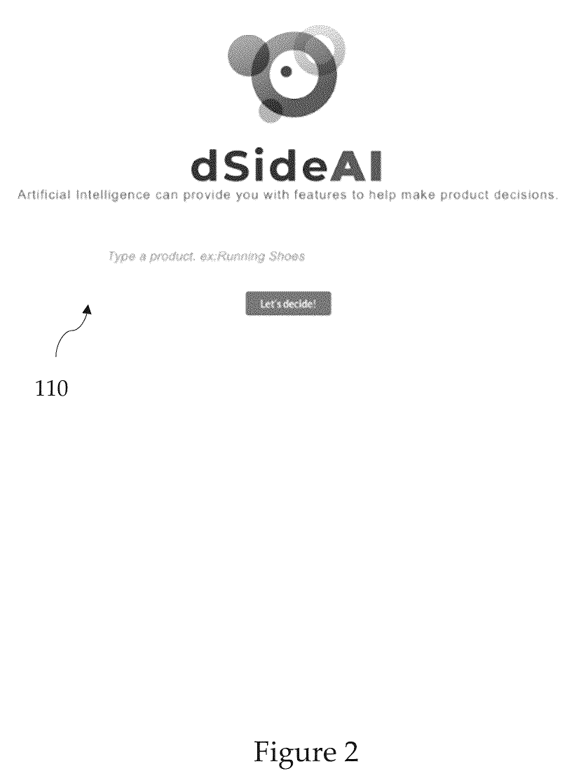

FIG. 2 schematically shows another configuration for a search entry section 110 of the user interface 100. In the illustrated embodiment, the search entry section 110 may appear on a dedicated search query page.

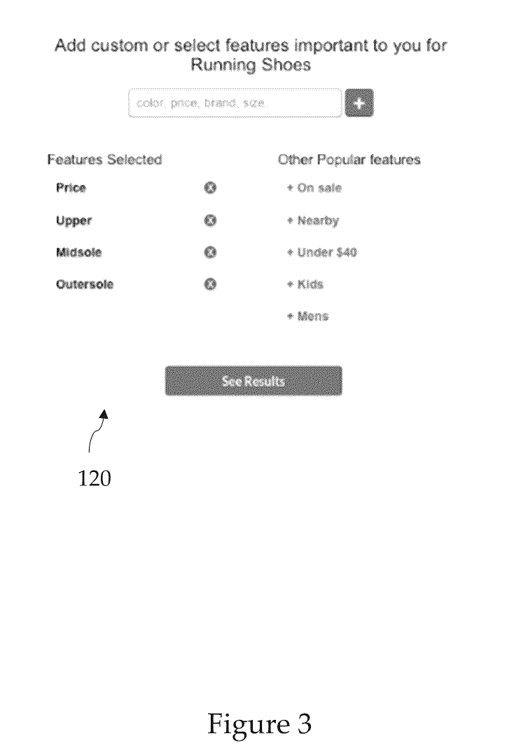

FIG. 3 shows a portion of the search adjustment section 120 for adding weighted factors or mandatory factors. In some embodiments, the portion may be displayed in the search query page. In some embodiments, the user inputs of adding and subtracting features may be used to determine an initial weight for the weighted factors. As illustrated, the section 120 may include suggested factors the user may add to considered factors.

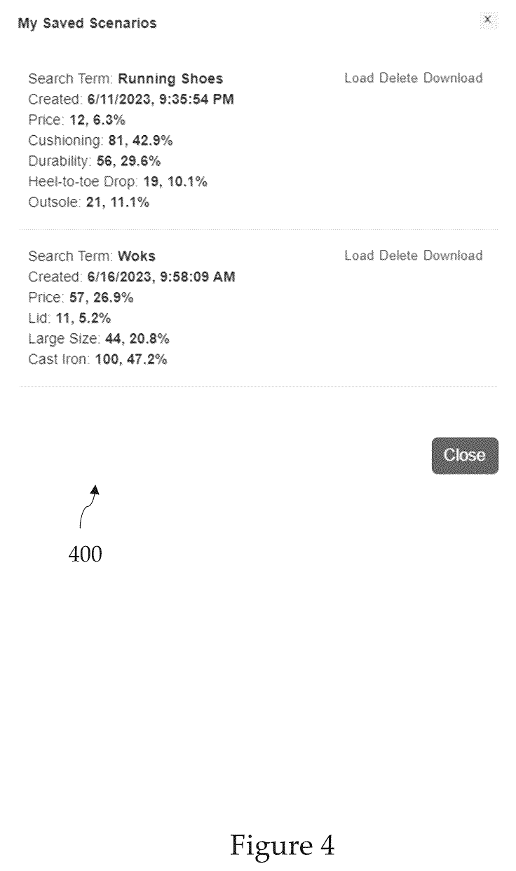

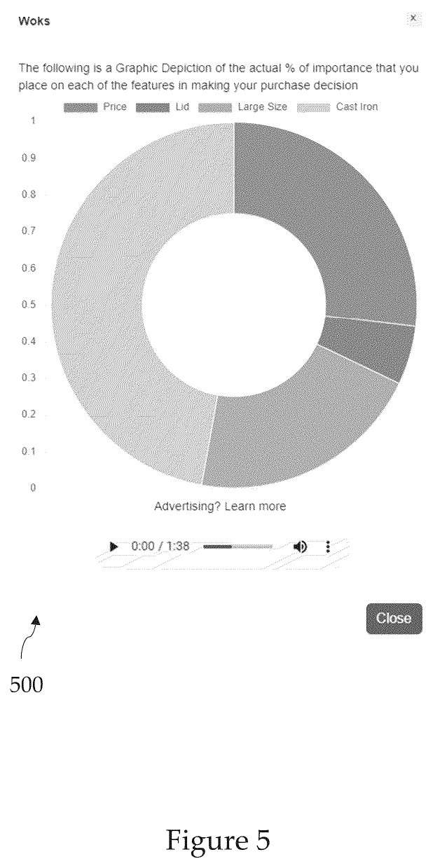

FIGS. 4 and 5 show different visual representations of a fingerprint in accordance with various embodiments. In some embodiments, the fingerprint, or collection of weighted factors indicated by user, may be a standardized data set transferable to other artificial intelligence systems or search engines as input, among other things. To give one example, the following may be a standardized fingerprint for a user:
Time Date, 1012 AM 04182023
Subject, Toaster 4 slot
Low Price, 20%, 47
Bagel Setting, 20%, 47
Size, 20%, 47
Toast Shade Settings, 20%, 47
Warming Rack, 20%, 47
Must Have, Condition New

The fingerprint includes a time and date, the search terms, the weighted factors and assigned weights, and the mandatory factor. In general, the fingerprint may be represented in the following form, among other standardized forms:
Definition of row 1
Time and Date
Definition of row 2
Values come from either of the below data entry areas on Home screen or Slider Results screen see below:
All remaining rows
Feature area structure is:
Feature 1, Importance %, Slider Position
Feature 2, Importance %, Slider Position
Feature 3, Importance %, Slider Position
Feature n, Importance %, Slider Position

In certain embodiments, the visual representation of a fingerprint in FIG. 5 maybe displayed by the user interface 100 by selecting the hyperlink “Why are these my results?”

In some embodiments, the fingerprint of a user may be shared with other users as a guide for performing a search. For example, one user, a subject matter expert, may share a fingerprint allowing other users to simulate a search performed by the subject matter expert to receive initial search results. For example, an expert photographer may share a portion of their fingerprint related to camera searches so that another user may use the expert's fingerprint for an initial search. The user may be able to see the search terms as well as the weighted factors and assigned weights. After performing the initial search, the user may adjust the weighted factors to personalize the search. As an example, if the expert assigned a moderate value to the price weighted factor, a user may increase or decrease the weighted factor value to received more personalized results.

In some embodiments, the fingerprint of the expert may be provided to another user by way of a hyperlink or a QR code, among other things. In some embodiments, the fingerprint may be shared on a social media site or a blockchain, among other things. In some embodiments, multiple shareable fingerprints may be stored in a searchable database users may search to select fingerprints from desired experts. When sharing a fingerprint, the expert may identify the portion of the fingerprint to be made public. For example, the expert may identify the portion of the fingerprint derived from a single search for cameras as the shareable portion of the user fingerprint.

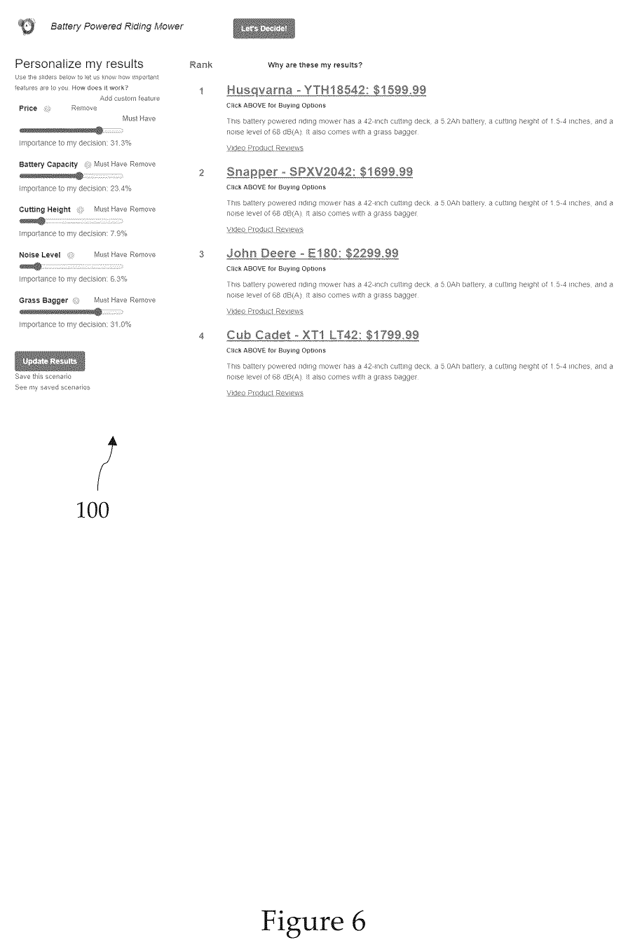

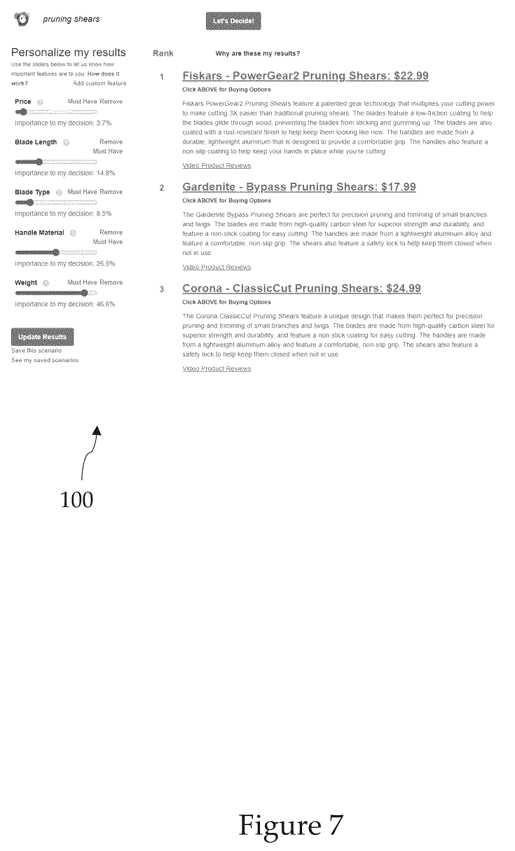

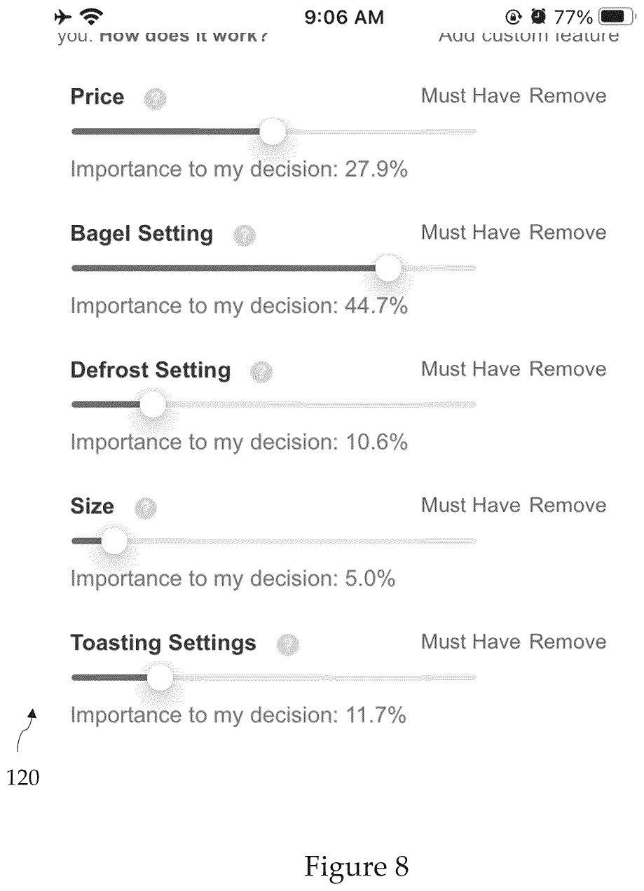

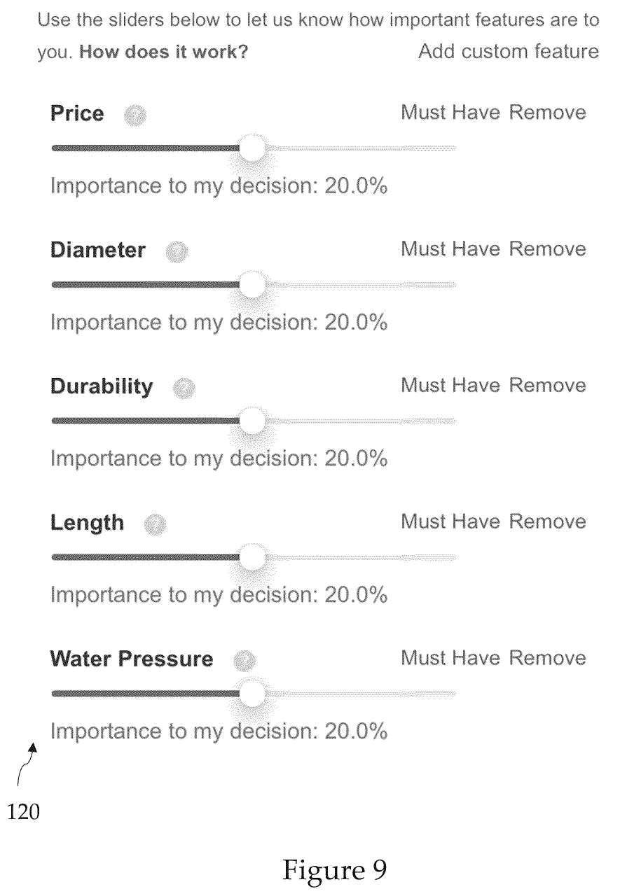

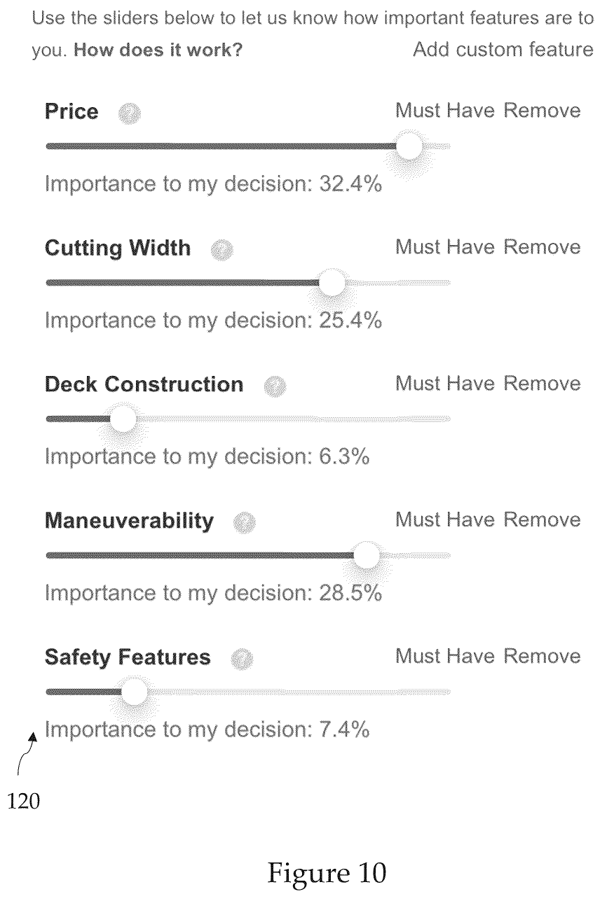

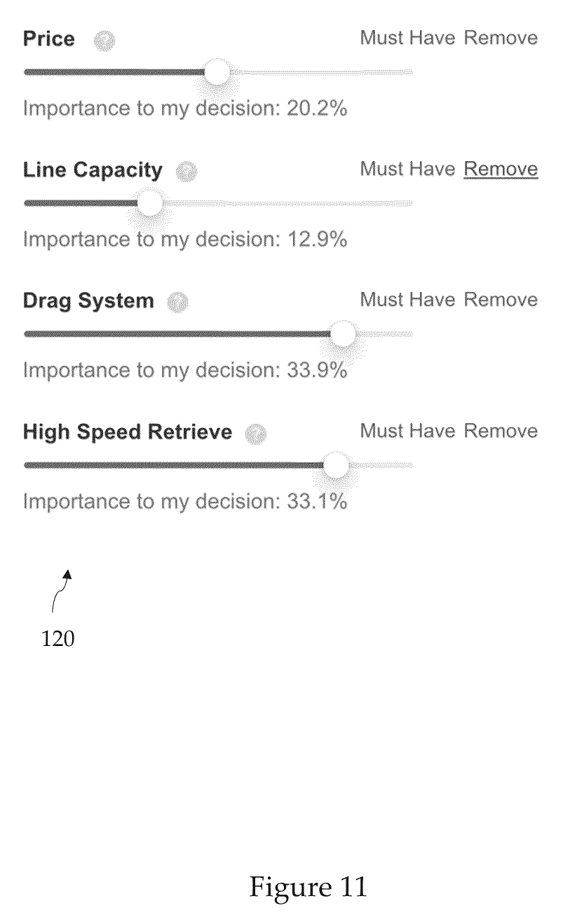

It should be appreciated the user interface 100 may be used to rank search results based on different sets of search terms, as illustrated in FIGS. 6 and 7, which illustrate searches for riding lawn mowers and pruning shears. In addition to shopping for goods, the user interface may also be used to search for services, or financial assets. For example, the user may enter a search query of “What stock should I buy?” While the user interface 100 may display initial results to answer the question, the user interface 100 may also be updated dynamically based on environment trigger conditions which affect which factors are considered for scoring (e.g., stock halt, weather prediction, option margin availability, option availability, stock rating changes). As shown in FIGS. 8-11, the user interface 100 may display factors significant only to certain items.

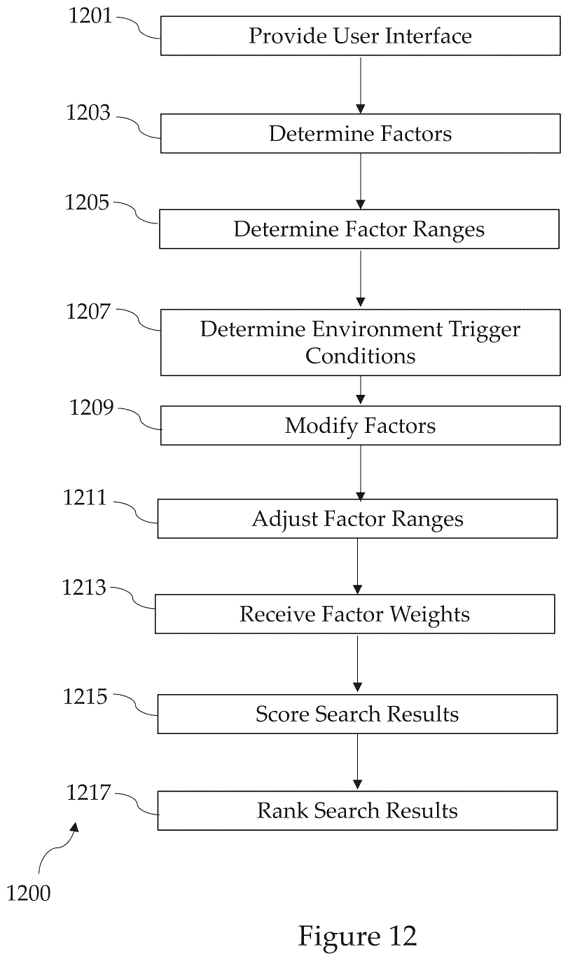

FIG. 12 shows an exemplary process 1200 for ranking dynamic search results in accordance with illustrative embodiment. Process 1200 may be implemented in whole or in part in one or more of the computing devices disclosed herein. In certain forms all functionalities may be performed by the same device. It shall be further appreciated that a number of variations and modifications to Process 1200 and are contemplated including, for example, the omission of one or more aspects of Process 1200, the addition of further conditionals and operations, or the reorganization or separation of operations and conditionals into separate processes.

Process 1200 begins at operation 1201 providing the user interface 100. After receiving a search query, the process 1200 determines factors with which to evaluate the search query, ranges for the values of the factors, and environment trigger conditions which may trigger an update to the search results, as illustrated in operations 1203, 1205, and 1207. Determining the factors may include receiving user input or using a generative AI model to generate factors based on the search query. The factor ranges may be based on logically possible values (e.g., 0-100% not 0%-150%) or search results product datasets (e.g., mowing deck widths for all search results), among other things. The environment trigger conditions may be set by a user or determined based on attributes of the search results. For example, a search for outdoor venues may use a weather trigger condition to rank search results based on a forecasted thunderstorm.

To present the search results dynamically, the user interface 100 responds to the environment trigger conditions. For example, the user interface 100 may modify one or more of the factors, as in operation 1209 or adjust factor ranges, as in operation 1211. Modifying the factors may include adding or removing factors. Adjusting factor ranges may include increasing the breadth of the range, increasing or decreasing the terminal values.

Once the factors are presented to the user, the user may weight each of the factors, as in operation 1213. After weighting, each of the possible search results may be scored based on the factors and ranked according to the scores for each search result.

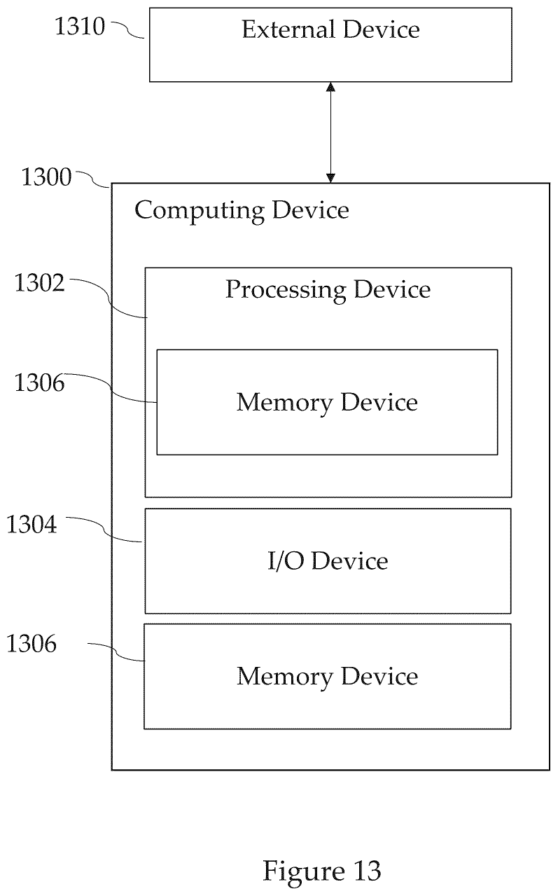

FIG. 13 schematically shows a computing device 1300 in accordance with various embodiments. The computing device 1300 is one example of a search engine or marketing engine which is used to perform one or more operations described herein. The computing device 1300 includes a processing device 1302, an input/output device 1304, and a memory device 1306. The computing device 1300 may be a stand-alone device, an embedded system, or a plurality of devices configured to generate one of the user interfaces described herein. Furthermore, the computing device 1300 may communicate with one or more external devices 1310.

The input/output device 1304 enables the computing device 1300 to communicate with an external device 1310. For example, the input/output device 1304 may be a network adapter, a network credential, an interface, or a port (e.g., a USB port, serial port, parallel port, an analog port, a digital port, VGA, DVI, HDMI, FireWire, CAT 5, Ethernet, fiber, or any other type of port or interface), among other things. The input/output device 1304 may be comprised of hardware, software, or firmware. The input/output device 1304 may have more than one of these adapters, credentials, interfaces, or ports, such as a first port for receiving data and a second port for transmitting data, among other things.

The external device 1310 may be any type of device that allows data to be input or output from the computing device 1300. For example, the external device 1310 may be a meter, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Furthermore, the external device 1310 may be integrated into the computing device 1300. More than one external device may be in communication with the computing device 1300. The computing device 1300 may monitor trigger condition by receiving data from one or more external devices 1310. For example, certain trigger conditions or changes thereof may trigger the addition of a weighted factor, the removal of a weighted factor, the adjustment of a range of values assignable to a weighted factor, the availability of a search result, or the ranking of a search result, among other things. For example, where an external device is a weather API, the trigger condition may indicate whether rain is forecasted, among other things.

The processing device 1302 may be a programmable type, a dedicated, hardwired state machine, or a combination thereof. The processing device 1302 may further include multiple processors, Arithmetic-Logic Units (ALUs), Central Processing Units (CPUs), Digital Signal Processors (DSPs), or Field-programmable Gate Arrays (FPGA), among other things. For forms of the processing device 1302 with multiple processing units, distributed, pipelined, or parallel processing may be used. The processing device 1302 may be dedicated to performance of just the operations described herein or may be used in one or more additional applications. The processing device 1302 may be of a programmable variety that executes processes and processes data in accordance with programming instructions (such as software or firmware) stored in the memory device 1306. Alternatively or additionally, programming instructions are at least partially defined by hardwired logic or other hardware. The processing device 1302 may be comprised of one or more components of any type suitable to process the signals received from the input/output device 1304 or elsewhere, and provide desired output signals. Such components may include digital circuitry, analog circuitry, or a combination thereof.

The memory device 1306 in different embodiments may be of one or more types, such as a solid-state variety, electromagnetic variety, optical variety, or a combination of these forms, to name but a few examples. Furthermore, the memory device 1306 may be volatile, nonvolatile, transitory, non-transitory or a combination of these types, and some or all of the memory device 1306 may be of a portable variety, such as a disk, tape, memory stick, or cartridge, to name but a few examples. In addition, the memory device 1306 may store data which is manipulated by the processing device 1302, such as data representative of signals received from or sent to the input/output device 1304 in addition to or in lieu of storing programming instructions, among other things. As shown in FIG. 13, the memory device 1306 may be included with the processing device 1302 or coupled to the processing device 1302, but need not be included with both.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

1. A method for ranking dynamic search results, comprising:
providing a user interface including a search results section and a search adjustment section;
determining a plurality of factors in response to receiving a search query;
determining a plurality of factor ranges corresponding to the plurality of factors;
displaying, using the search adjustment section, a plurality of controllable elements corresponding to the plurality of factors and the plurality of factor ranges;
determining a plurality of environment trigger conditions;
modifying the plurality of factors in response to determining a first environment trigger condition of the plurality of environment trigger conditions; and
adjusting the plurality of factor ranges in response to determining a second environment trigger condition of the plurality of environment trigger conditions;
automatically displaying, using the search adjustment section, a modified plurality of controllable elements corresponding to the modified plurality of factors and the adjusted plurality of factor ranges;
receiving, using the plurality of controllable elements, a plurality of factor weights for the modified plurality of factors, the plurality of factor weights being within the adjusted plurality of factor ranges;
scoring a plurality of search results using the plurality of factor weights;
ranking the plurality of search results in response to scoring the plurality of search results; and
displaying, using the search results section, the plurality of search results according to the ranking,
wherein the first environment trigger condition or the second environment trigger condition includes a change in availability of an item.

2. The method of claim 1, wherein the plurality of environment trigger conditions includes an updated essential status for one of the plurality of factors, and wherein the method comprises removing a portion of the plurality of search results from the plurality of search results based on one factor of the plurality of factors corresponding to the updated essential status.

3. The method of claim 1, comprising: adding a new search result to the plurality of search results in response to a third environment trigger condition of the plurality of environment trigger conditions.

4. (canceled)

5. The method of claim 1, comprising:
removing a first search result from the plurality of search results in response to evaluating a third environment trigger condition of the plurality of environment trigger conditions.

6. The method of claim 5, comprising:
rescoring the plurality of search results in response to evaluating a fourth environment trigger condition of the plurality of environment trigger conditions.

7. The method of claim 1, wherein modifying the plurality of factors is either:
adding a new factor to the plurality of factors in response to one of the plurality of environment trigger conditions; or
removing a first factor from the plurality of factors in response to one of the plurality of environment trigger conditions.

8. The method of claim 1, wherein the user interface is configured to provide a vendor search result, and
wherein the method comprises:
updating the plurality of factors in response to the plurality of environment trigger conditions; and
updating the vendor search result in response to the updated plurality of factors.

9. The method of claim 1, wherein the user interface is configured to provide a vendor search result, and
wherein the method comprises:
updating the plurality of factor ranges in response to the plurality of environment trigger conditions; and
updating the vendor search result in response to the updated plurality of factor ranges.

10. The method of claim 1, comprising:
capturing an image of a bar code corresponding to a supplemental search result,
reranking the plurality of search results,
wherein the plurality of environment trigger conditions includes a receipt of a new search result, and
wherein the reranked plurality of search results includes a rank for the new search result.

11. A computer program product for use on a computer system for ranking dynamic search results, the computer program product comprising a tangible, non-transient computer usable medium having computer readable program code thereon, the computer readable program code comprising:
program code for providing a user interface including a search results section and a search adjustment section;
program code for determining a plurality of factors in response to receiving a search query;
program code for determining a plurality of factor ranges corresponding to the plurality of factors;
program code for displaying, using the search adjustment section, a plurality of controllable elements corresponding to the plurality of factors and the plurality of factor ranges;
program code for determining a plurality of environment trigger conditions;
program code for modifying the plurality of factors in response to determining a first environment trigger condition of the plurality of environment trigger conditions; and
program code for adjusting the plurality of factor ranges in response to determining a second environment trigger condition of the plurality of environment trigger conditions;
program code for automatically displaying, using the search adjustment section, a modified plurality of controllable elements corresponding to the modified plurality of factors and the adjusted plurality of factor ranges;
program code for receiving, using the plurality of controllable elements, a plurality of factor weights for the modified plurality of factors, the plurality of factor weights being within the adjusted plurality of factor ranges;
program code for scoring a plurality of search results using the plurality of factor weights;
program code for ranking the plurality of search results in response to scoring the plurality of search results; and
program code for displaying, using the search results section, the plurality of search results according to the ranking,
wherein the first environment trigger condition or the second environment trigger condition includes a change in availability of an item.

12. The computer program product of claim 11, wherein the plurality of environment trigger conditions includes an updated essential status for one of the plurality of factors, and wherein the computer program product is comprises program code for removing a portion of the plurality of search results from the plurality of search results based on one factor of the plurality of factors corresponding to the updated essential status.

13. The computer program product of claim 11, comprising program code for adding a new search result to the plurality of search results in response to a third environment trigger condition of the plurality of environment trigger conditions.

14. (canceled)

15. The computer program product of claim 1, comprising:
program code for removing a first search result from the plurality of search results in response to evaluating a third environment trigger condition of the plurality of environment trigger conditions.

16. The computer program product of claim 15, comprising:
program code for rescoring the plurality of search results in response to evaluating a fourth environment trigger condition of the plurality of environment trigger conditions.

17. The computer program product of claim 11, wherein modifying the plurality of factors is either:
adding a new factor to the plurality of factors in response to one of the plurality of environment trigger conditions; or
removing a first factor from the plurality of factors in response to one of the plurality of environment trigger conditions.

18. The computer program product of claim 11, wherein the user interface is configured to provide a vendor search result, and
wherein the computer program product comprises:
program code for updating the plurality of factors in response to the plurality of environment trigger conditions; and
program code for updating the vendor search result in response to the updated plurality of factors.

19. The computer program product of claim 11, wherein the user interface is configured to provide a vendor search result, and
wherein the computer program product comprises:
program code for updating the plurality of factor ranges in response to the plurality of environment trigger conditions; and
program code for updating the vendor search result in response to the updated plurality of factor ranges.

20. The computer program product of claim 11, comprising:
program code for capturing an image of a bar code corresponding to a supplemental search result; and
reranking the plurality of search results, wherein the plurality of environment trigger conditions includes a receipt of a new search result, and
wherein the reranked plurality of search results includes a ranking for the new search result.
